(19) United States
(12) Patent Application Publication
(10) Pub. No.: US 2019/0370752 A1
(43) Pub. Date: Dec. 5, 2019

(54) JOB-POST RECOMMENDATION

(71) Applicant: Microsoft Technology Licensing, LLC, Redmond, WA (US)

(72) Inventors: Keqing Liang, Sunnyvale, CA (US); Monica Marie Lewis, Menlo Park, CA (US); Sumedha Swamy, San Jose, CA (US); Qing Duan, Santa Clara, CA (US); Wen Pu, Santa Clara, CA (US)

(21) Appl. No.: 15/994,998

(22) Filed: May 31, 2018

(51) Int. Cl. G06Q 10/10; G06Q 10/06; G06F 15/18

(52) U.S. Cl. CPC G06Q 10/1053; G06F 15/18; G06Q 10/06315

(57) ABSTRACT

Methods, systems, and computer programs are presented for determining a recommended daily budget for a job post. One method includes operations for identifying an initial budget value for recommending a daily budget when a job poster is adding a job post, and for performing a test to determine responses of job posters when the recommended daily budget is presented as a function of a multiplier applied to the initial budget value. Further, the method includes operations for defining a model to determine committed bookings as a function of the multiplier, determining based on the model a value of the multiplier that maximizes the committed bookings, and setting a new initial budget value to the initial budget value times the value of the multiplier that maximizes the committed bookings. Additionally, the new initial budget value is presented in a user interface when job posters add new job posts.

### TECHNICAL FIELD

The subject matter disclosed herein generally relates to methods, systems, and programs for analyzing data to provide users recommendations for setting a budget when posting a job.

### BACKGROUND

When a recruiter posts a job on a website (e.g., jobs bulletin board or any other online system), the recruiter has to decide how much money to spend in order to gain enough visibility with quality candidates. Several variables affect the effectiveness of the job post, such as the size of the pool of potential candidates, competition for hiring for a given job title, geographic location of the job, job salary, etc. Therefore, it may be difficult for a recruiter, who may be dealing with hundreds of different jobs, to come up with a reasonable amount to spend on the job post to get the desired results.

In some cases, the jobs website may provide a recommendation to the recruiter. However, the recommendation may be too high, which may cause the recruiter to skip posting the job, or the recommendation may be too low, which may result in poor performance for the job post and a missed opportunity for revenue for the jobs website.

### BRIEF DESCRIPTION OF THE DRAWINGS

Various ones of the appended drawings merely illustrate example embodiments of the present disclosure and cannot be considered as limiting its scope.

FIG. 1 illustrates a user interface for posting a job opening, according to some example embodiments.

FIG. 2 illustrates the estimation of committed bookings, according to some example embodiments.

FIG. 3 illustrates the process for optimizing committed bookings based on experiment data, according to some example embodiments.

FIG. 4 is a chart showing the daily budget and the conversion rate as functions of the recommended budget multiplier, according to some example embodiments.

FIG. 5 is a chart showing the optimal committed bookings, according to some example embodiments.

FIG. 6 illustrates the training and use of a machine-learning program, according to some example embodiments.

FIG. 7 is a chart showing the calculation of the linear regression model for the daily budget, according to some example embodiments.

FIG. 8 is a block diagram illustrating an example embodiment of a high-level client-server-based network architecture 802, according to some example embodiments, including a social networking server 812.

FIG. 9 is a flowchart of a method for determining a recommended daily budget for a job post, according to some example embodiments.

FIG. 10 is a block diagram illustrating an example of a machine upon or by which one or more example process embodiments described herein may be implemented or controlled.

### DETAILED DESCRIPTION

Example methods, systems, and computer programs are directed to determining a recommended daily budget for a job post. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The different elements that affect performance of job posts are broken down into individual models, which are then executed to identify the impact of each of the elements. In some aspects, the recommended daily budget is analyzed to determine the optimum daily budget to recommend based on the behavior of the different elements. The result is improved job-post performance and potentially an increase in the daily budget committed by the job poster.

Typically, daily budgets for job posts are recommended based on simple calculations using historical click rate data, or other performance metrics for job posts that were previously posted. However, because not all job posts perform similarly, these simplistic methods frequently will lead to inaccurate recommendations, leading to excess- or under-budgeting. By using the methods described herein, the daily budget recommendations are far more accurate, thereby, leading to more efficient and accurate budgeting.

In some implementations, an experiment is performed using random suggested budgets, and the performance of the job posts in the experiment is measured. Additionally, two or more models are defined to optimize the performance of the recommended daily budget when posting a job. The first model tracks the conversion rate for posting jobs when a recruiter visits the job posting webpage, and the second model tracks the behavior of the daily budget selected by the recruiter. The two models are then combined to optimize the committed bookings for the job posts.

In one embodiment, a method is provided. The method includes operations for identifying an initial budget value for recommending a daily budget when a job poster is adding a job post, performing a test to determine responses of job posters when the recommended daily budget is presented as a function of a multiplier applied to the initial budget value, and defining a model to determine committed bookings as a function of the multiplier. Additionally, the method includes operations for determining, based on the model, a value of the multiplier that maximizes the committed bookings, and for setting a new initial budget value to the initial budget value times the value of the multiplier that maximizes the committed bookings. The method further includes causing presentation, in a user interface, of the new initial budget value when job posters add new job posts.

In another embodiment, a system includes a memory comprising instructions and one or more computer processors. The instructions, when executed by the one or more computer processors, cause the one or more computer processors to perform operations comprising: identifying an initial budget value for recommending a daily budget when a job poster is adding a job post; performing a test to determine responses of job posters when the recommended daily budget is presented as a function of a multiplier applied to the initial budget value; defining a model to determine committed bookings as a function of the multiplier; determining, based on the model, a value of the multiplier that maximizes the committed bookings; setting a new initial budget value to the initial budget value times the value of the multiplier that maximizes the committed bookings; and causing presentation, in a user interface, of the new initial budget value when job posters add new job posts. It is noted that committed bookings are maximized with constrains on the order conversion rate drop and the cost per application increase.

In yet another embodiment, a machine-readable storage medium (e.g., a non-transitory storage medium) includes instructions that, when executed by a machine, cause the machine to perform operations comprising: identifying an initial budget value for recommending a daily budget when a job poster is adding a job post; performing a test to determine responses of job posters when the recommended daily budget is presented as a function of a multiplier applied to the initial budget value; defining a model to determine committed bookings as a function of the multiplier; determining, based on the model, a value of the multiplier that maximizes the committed bookings; setting a new initial budget value to the initial budget value times the value of the multiplier that maximizes the committed bookings; and causing presentation, in a user interface, of the new initial budget value when job posters add new job posts.

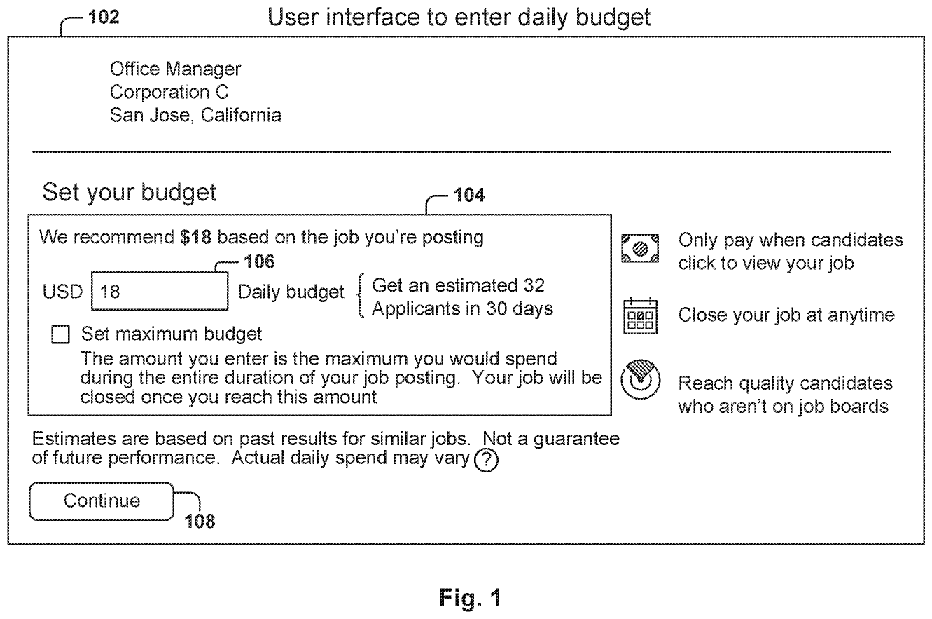

FIG. 1 illustrates a user interface 102 for posting a job opening, according to some example embodiments. In some implementations, when a job poster enters a job opening, the job poster enters information about the desired candidate, such as title, education, years of experience, salary range, geographic location, etc. Additionally, the job poster may select how much to spend to present this job post the potential candidates. In general, the higher the budget, the higher the number of candidates that the job posts will reach, thereby increasing the possibilities of hiring a good candidate.

In some example embodiments, if the user selects an option to set the daily budget of the job post; the user interface 102 is presented on a device being accessed by the job poster. The user interface 102 provides a short description of the job and an area 104 to set the budget. A recommendation is provided for the daily budget (e.g., $18) and is placed in an input box 106. The job poster is able to modify the suggested daily budget to another number, which may be higher or lower than the recommended value.

In addition, a check box is provided to set a maximum budget. If the user selects to set the maximum budget, a separate user interface is provided for entering the maximum budget, and the user will never spend an amount greater than the set maximum budget. If the user does not select a maximum budget, the system will aim at a daily spending that is about the amount specified in the daily budget for a preset period of time (e.g., 30 days), or until the job is closed by the job poster. The actual amount spent on a day may be less than the daily budget, if the system is not able to identify enough candidates for that day.

It is to be noted that; in some implementations, the amount spent is based on the number of job posts, based on the number of clicks (e.g., selections) of the job post by candidates, or a combination thereof. In the example illustrated in FIG. 1, the daily expenditures are based on the number of candidates who click on the job post, an option referred to as Pay Per Click (PPC).

If the system recommends a high daily budget, then it is possible to obtain a high income for the job post, as long as the user accepts the daily budget. On the other hand, a high daily budget may make the job poster reconsider this job post on this website because the price may be perceived as too high. In this case, the system may lose an income opportunity if the job poster does not place the order.

The conversion rate is the percentage of jobs posted in relationship to the number of job post requests that are initialized in the system, i.e., the number of jobs posted divided by the number of unique job posters that visited the job posting page. The difference between the number of initialized job post requests and the number of jobs posted is equal to the number of times that one job poster decides to quit the operation of adding a new job post. For example, if 100 unique job posters accessed the job post creation user interface and, from those 100 unique job posters, 60 job posts are created, the conversion rate is equal to 60%. The higher the conversion rate, the better for the jobs website because of the higher number of job posts created.

The total revenue may differ from the budget as the total revenue is based on the number of job views by potential candidates. Further, the total revenue for a given job post is correlated to the daily budget times the number of days the job post stays open (assuming that the daily budget is spent every day). In some implementations, the job poster may cancel the job post at any time.

Further, a continue button 108 is selectable by the user to continue with the process to place the job post after selecting the daily budget.

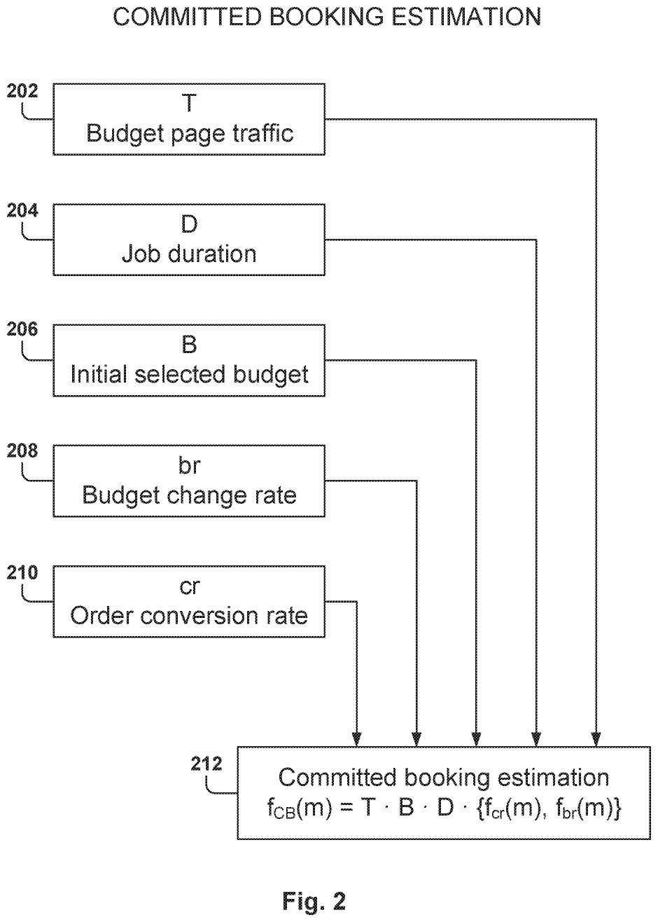

FIG. 2 illustrates the estimation of committed bookings, according to some example embodiments. Committed bookings CB 212 is the amount of revenue (e.g., bookings) obtained from posting jobs, and it depends on several factors.

These factors include budget page traffic T 202, a job duration D 204, an initial selected budget B 206 (e.g., the initial selected daily budget), a budget change rate br 208, and an order conversion rate cr 210. The budget page traffic T 202 is the number of visits to the daily budget page shown in the user interface 102 within a given period. For example, if job posters reached the daily budget page 1000 times within a year, then T is equal to 1000 for the year. Further, the job duration D 204 is the number of days that a job is posted, and the initial selected budget B 206 is a predefined parameter for recommending the daily budget. Thus, B may be set manually initially, but after the recommendation of the daily budget is optimized, B may change to a new value. Over time, periodic iterations may be performed to continue refining B.

Further, the budget change rate br 208 is a rate of change to be applied to B to obtain the recommended daily budget. For example, if br is 1.2, then the recommended daily budget will be br·B.

Thus, to estimate the committed bookings CB 212, these factors are multiplied together. Multiplying T by cr results in the number of job posts committed by the job posters. For example, if 500 job posters reach the daily budget page and 70% actually post jobs, the number of job posters is 350. Some job posters may post more than one job.

Further, if the recommended daily budget br·B is multiplied by D (e.g., the number of days the job post is open), the result is the income generated by an average job. If this income per job (br·B·D) is multiplied by the number of jobs posted (T·cr), then the result is the committed bookings CB 212. (br·B·D·T·cr).

In some example embodiments, the analysis for optimizing committed bookings is performed for each standardized job type. The job type may be defined by the title for the person being searched, and since some titles may be similar or related, the similar job titles are put together within the same category, the standardized job type.

As discussed below, AB testing is performed to experiment with different daily budget recommendations for each standardized job type. A random daily budget is selected as a recommendation for the job posts selected for the experiment. The random recommended daily budgets may be expressed as riv where in is a factor referred to as the multiplier. That is, the multiplier in is a factor applied to B to obtain a recommendation for a daily budget.

In some example embodiments, the random daily budget is selected within a range of possible values. For example, in is selected within the range between 0.75 and 2, but other ranges are also possible, such as between a lower range boundary a between 0.25 and 0.9, and an upper range boundary b between 1.1 and 5. Other values are also possible.

In some example embodiments, the distribution for in during the experiment is a uniform distribution; therefore, values for in between a and b are selected with equal probability.

Based on the experiment results, models are created based on the multiplier, one for cr and another one for br. In other embodiments, additional parameters may also be modeled as a function of m. Therefore, cr may be expressed as ƒ_{cr}(m), which is the function that predicts cr based on in, and br may be expressed as ƒ_{br}(m), which is the function that predicts br based on m.

Thus, the committed bookings CB 212 may be expressed as a function ∫_{CB}(m), because two of the parameters are functions of m, as follows:

θ_{CB}(m)=T·B·D·∫_{cr}(m)·ƒ_{br}(m) ((1)

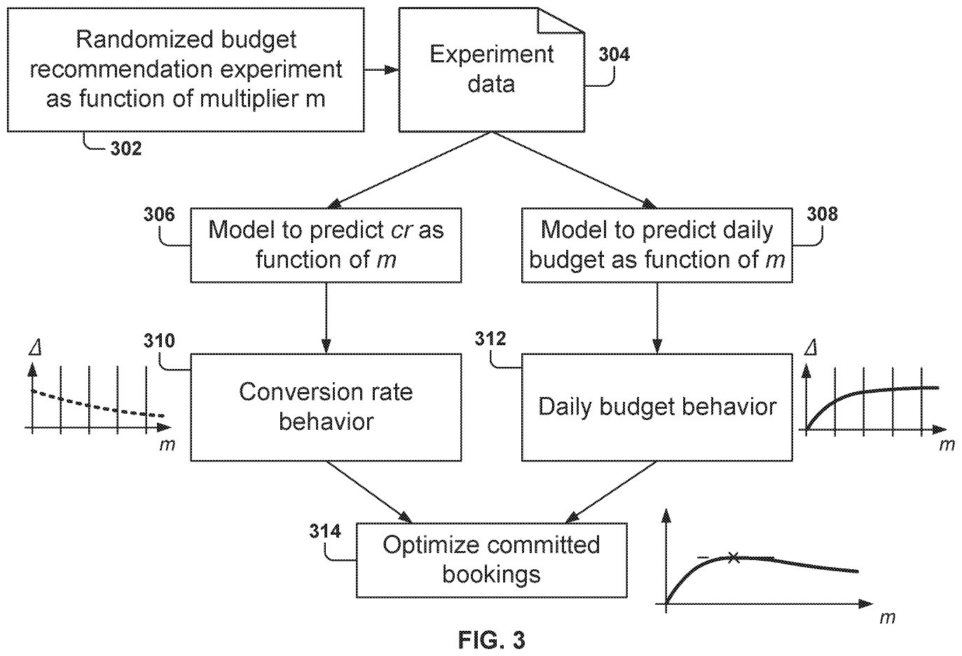

FIG. 3 illustrates the process for optimizing committed bookings based on experiment data, according to some example embodiments. It is known that some job posters are willing to pay a higher amount to increase the visibility of their job posts. This means that, if the suggested daily budget is increased, some customers will accept and increase their bookings. However, some customers may get discouraged and disregard the advice; these customers may quit posting the job because they feel that the price is too high or may enter a daily budget that is less than the recommended daily budget.

One of the goals is to optimize the recommended daily budget to increase committed bookings overall. A multi-layered approach is used to test modeling for different parameters. Each parameter is modeled independently, so it is possible to fine-tune each of the parameters separately, which makes the system more flexible by offering independent and separate controls. In the example embodiment illustrated in FIG. 3, two different models are used, as described above. However, other embodiments may utilize additional models.

To collect data for the models, an experiment 302 is performed to determine the response of job posters to different daily budgets. As discussed above, the multiplier in is utilized as the variable for the experiment, and m determines the suggested daily budget. In one example embodiment, m has an upper bound and a lower bound with a uniform distribution. In other example embodiments, different distributions may be utilized, and the upper and lower bounds may be increased, decreased, or eliminated. For example, a gaussian distribution may be used centered around B, but other possible distributions may be utilized.

The uniform distribution within defined boundaries around the existing suggested daily budget works well to fine-tune the model. It is to be noted that the model may be run multiple times, each time providing an adjustment of the suggested daily budget. Therefore, if the optimal suggested daily budget is outside the initial boundaries for the experiment, the suggested daily budget will be adjusted during the first run of the model, and then adjusted further in future optimizations.

The experiment 302 utilizes a randomized daily budget recommendation where the variable is the multiplier m. During the experiment, job posters are offered different suggested daily budgets and their responses recorded to obtain experiment data 304. The data captured includes the value of in, identification of the job poster, job post data, cost per click, whether the job poster quit the job-posting process, etc. For example, if B is 10 and the recommended daily budget offered is 15, the job poster may accept the recommendation, enter a different daily budget (higher or lower than the suggested daily budget), or quit the process.

During one experiment, the average suggested daily budget was higher than the original B, and the results were an increase of about 15% in the daily budgets accepted by job posters, an increase of about 12% in committed bookings, and a 5% increase in total revenue, while the conversion rate decreased slightly by about 1.5%.

In some example embodiments, the number of possible different standardized job titles is rather high (e.g., around 40,000); therefore, the job tides may be placed in buckets in order to increase the amount of data available for each bucket.

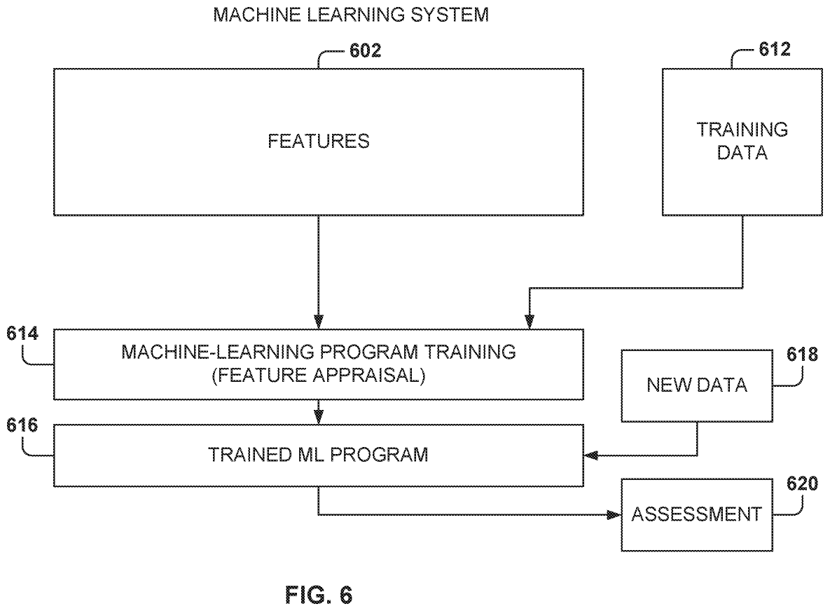

At operation 306, a model is created to predict cr based on the multiplier m. More details about implementation of the model utilizing a machine-learning program (MLP) are provided below with reference to FIG. 6. At operation 308, a second model is built to predict the daily budget based on the multiplier m. It is to be noted that the daily budget is equal to br(m)·B; therefore, the model for predicting the daily budget is equivalent to the model for predicting br (e.g., ƒ_{br}(m) as illustrated in FIG. 2) because B is a constant.

In some example embodiments, the first model for the conversion rate is a logistic-regression model, and the second model for the daily budget is a linear-regression model, but other embodiments may utilize other machine-learning programs.

The models are trained with the experiment data 304 based on job-related features and user-related features. Once the models are trained, the models can predict what the conversion rate cr and the daily budget will be when different values of m are selected.

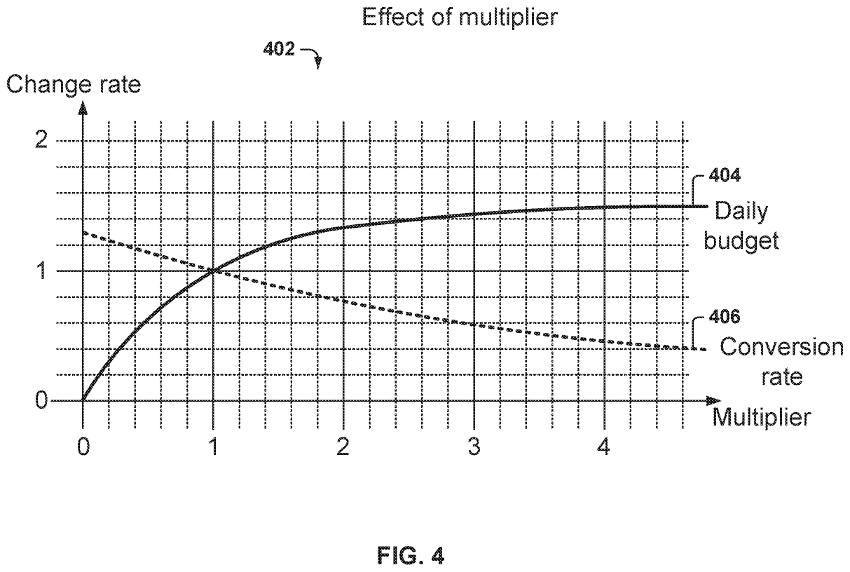

At operation 310, the behavior of cr as a function of m is determined, which means determining the percentage of job posts created once a user reaches the page for selecting the daily budget. At operation 312, the daily budget behavior as a function of m is determined, which means predicting the daily budget for the different values of m. More details regarding cr and the daily budget are provided below with reference to FIG. 4.

At operation 314, the committed bookings are optimized based on cr and the daily budget as a function of m. This includes identifying the value of in that generates the maximum predicted committed bookings. As the suggested daily budget increases, the selected daily budget tends to increase, but on the other hand, cr tends to decrease. These two opposing forces are analyzed to determine the best value of m for the highest committed bookings. The result may be an m greater than 1, which means that higher daily budgets will outweigh the effect of the decrease in cr. If the best in for getting the highest committed bookings is less than 1, then it means that, although the daily budgets may be lower, an increase in cr will result in more job posts and higher committed bookings.

FIG. 4 is a chart 402 showing the daily budget and the conversion rate for a job post type as functions of the recommended budget multiplier, according to some example embodiments. The chart 402 includes a daily budget line 404 and a conversion rate line 406. The horizontal axis is for the multiplier m, and the vertical axis is for the change rate of the respective values.

As would be expected, as the multiplier grows (which means that the suggested daily budget grows), the daily budget for job posts grows and the conversion rate decreases. When the multiplier has a value of 1, it means that the suggested daily budget does not change and the change rate for the daily budget and the conversion rate also stays at 1.

The chart 402 shows the behavior of the opposing forces. The goal is to find the optimal volume for the committed bookings by combining the data from both lines 404 and 406.

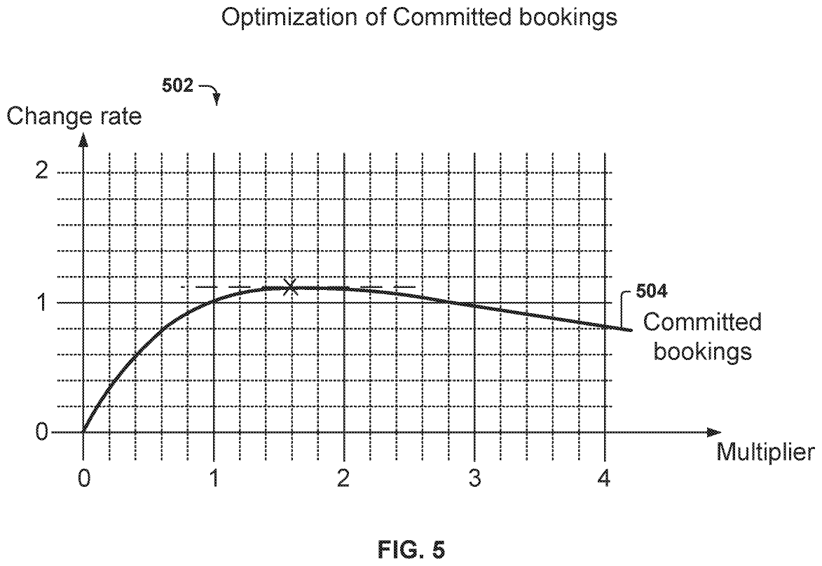

FIG. 5 is a chart 502 showing the optimal committed bookings, according to some example embodiments. A committed-bookings line 504 illustrates an example of how the committed bookings change as a function of the multiplier m.

The data illustrated in FIG. 4 is combined to calculate the committed bookings by utilizing equation (1) as described above with reference to FIG. 2. Since one of the models is for the daily budget DB and DB is equal to br(m)·B, equation (1) may be expressed as follows:

ƒ_{CB}(m)=T·D·ƒ_{cr}(m)·ƒ_{DB}(m) (2)

Thus, equation (2) may be used to obtain the value of committed bookings based on the model for the conversion rate and the model for the daily budget. For each value of m, the value of committed bookings is calculated and the change rate determined.

In the example illustrated in the chart 502, the maximum committed bookings corresponds to an m of about 1.6. In some example embodiments, the system adjusts the recommended daily budget by making hr equal to the m that provides the maximum committed bookings (e.g., br equals 1.6 for this example). The new suggested daily budget B will be set to br·B, with hr being the m that provides the maximum committed bookings. If the process is repeated over time, the value of B may be fine-tuned based on the system behavior to continue optimizing the committed bookings value. The computer system is configured to find matches to job applications for a limited amount of time set based upon a budget. This way, computer resources are used efficiently and a user's budgetary concerns, coincidentally, also are satisfied.

FIG. 6 illustrates the training and use of a machine-learning program, according to some example embodiments. In some example embodiments, machine-learning programs (MLPs), also referred to as machine-learning algorithms or tools, are utilized to perform operations associated with searches, such as job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 612 in order to make data-driven predictions or decisions expressed as outputs or assessments 620. Although example embodiments are presented with respect to a few machine-learning tools, the principles presented herein may be applied to other machine-learning tools.

In some example embodiments, different machine-learning tools may be used. For example, linear regression, logistic regression. Naive-Bayes, Random Forest (RF), neural networks (NN), matrix factorization, and Support Vector Machines (SVM) tools may be used for analyzing job posts.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number), The machine-learning algorithms utilize the training data 612 to find correlations among identified features 602 that affect the outcome.

The machine-learning algorithms utilize features 602 for analyzing the data to generate assessments 620. A feature 602 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

The machine-learning algorithms utilize the training data 612 to find correlations among the identified features 602 that affect the outcome or assessment 620. In some example embodiments, the training data 612 includes labeled data, which is known data for one or more identified features 602 and one or more outcomes.

With the training data 612 and the identified features 602, the machine-learning tool is trained at operation 614. The machine-learning tool appraises the value of the features 602 as they correlate to the training data 612. The result of the training is the trained machine-learning program 616.

When the machine-learning program 616 is used to perform an assessment, new data 618 is provided as an input to the trained machine-learning program 616, and the machine-learning program 616 generates the assessment 620 as output. For example, when a message is checked for an action item, the machine-learning program utilizes the message content and message metadata to determine if there is a request for an action in the message.

In some example embodiments, the models created in operations 306 and 308 utilize the multiplier in as a feature and one or more features from a set of features. The set of features includes job features, job-poster features, social-network-profile features, company features, and response features.

The job features may include job identifier, job poster, company, recommended daily budget, whether the job poster posted the job after reaching the daily budget page, committed daily budget, job description, title description, title identifier, super-title, industry, location, region, salary range, desired skills, seniority, cost per acquisition (CPA), and amount of time the job post stays open.

The job-poster features may include job-poster type (new or repeat), number of jobs posted previously, jobs posted previously, average budget used previously, and conversion rate for the job poster.

The social-network-profile features may include data about users of jobs website, including name, title, super-title, years of experience, skills, job posts presented to the user, job posts viewed by the user, education, experience, geographic location, and activities of the user in the social network.

The company features may include company identifier, company name, annual revenue, number of employees, industry, region, and number of jobs posted within a predetermined period (e.g., within last 12 months, last year).

The response features may include recommended daily budget, submitted daily budget, difference between the recommended daily budget and the submitted daily budget, recommended total budget, submitted total budget, actual total budget spent while the job post is open, cost per click, number of times the job post is presented to candidates, and number of clicks on the job post.

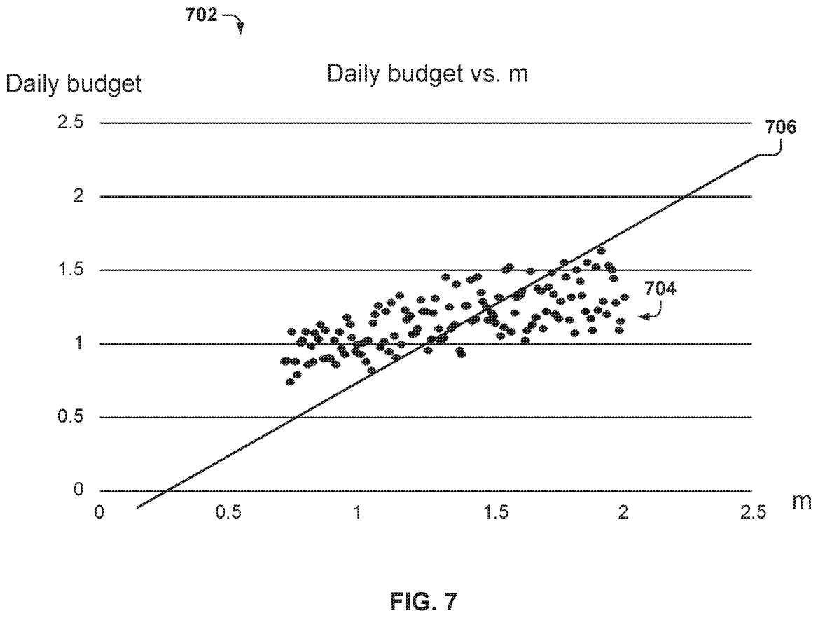

FIG. 7 is a chart 702 showing the calculation of the linear regression model for the daily budget, according to some example embodiments. The chart 702 illustrates a plurality of daily-budget observations 704 during the experiments for multiple values of m (horizontal axis). As a result of the linear regression, a line 706 is determined to predict how the daily budget varies as a function of m.

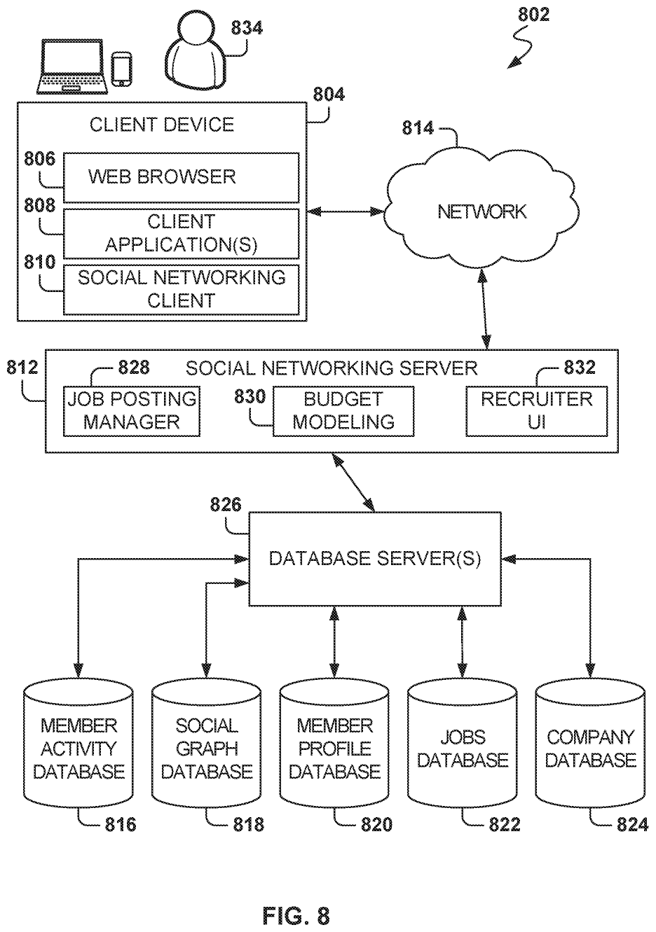

FIG. 8 is a block diagram illustrating an example embodiment of a high-level client-server-based network architecture 802, according to some example embodiments, including a social networking server 812. The social networking server 812 provides server-side functionality via a network 814 (e.g., the Internet or a wide area network (WAN)) to one or more client devices 804. FIG. 8 illustrates, for example, a web browser 806, client application(s) 808, and a social networking client 810 executing on a client device 804. The social networking server 812 is further communicatively coupled with one or more database servers 826 that provide access to one or more databases 816-824.

The client device 804 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a user 834 may utilize to access the social networking server 812. In some embodiments, the client device 804 may comprise a display module (not shown) to display information (e.g., in the form of user interfaces). In further embodiments, the client device 804 may comprise one or more of touch screens, accelerometers, gyroscopes, cameras, microphones, Global Positioning System (GPS) devices, and so forth.

In one embodiment, the social networking server 812 is a network-based appliance that responds to initialization requests or search queries from the client device 804. One or more users 834 may be a person, a machine, or other means of interacting with the client device 804. In various embodiments, the user 834 is not part of the network architecture 802, but may interact with the network architecture 802 via the client device 804 or another means.

The client device 804 may include one or more applications (also referred to as “apps”) such as, but not limited to, the web browser 806, the social networking client 810, and other client applications 808, such as a messaging application, an electronic mail (email) application, a news application, and the like. In some embodiments, if the social networking client 810 is present in the client device 804, then the social networking client 810 is configured to locally provide the user interface for the application and to communicate with the social networking server 812, on an as-needed basis, for data and/or processing capabilities not locally available (e.g., to access a member profile, to authenticate a user 834, to identify or locate other connected members, etc.). Conversely, if the social networking client 810 is not included in the client device 804, the client device 804 may use the web browser 806 to access the social networking server 812.

Further, while the client-server-based network architecture 802 is described with reference to a client-server architecture, the present subject matter is of course not limited to such an architecture, and could equally well find application in a distributed, or peer-to-peer, architecture system, for example.

In addition to the client device 804, the social networking server 812 communicates with the one or more database server(s) 826 and database(s) 816-824. In one example embodiment, the social networking server 812 is communicatively coupled to a member activity database 816, a social graph database 818, a member profile database 820, a jobs database 822, and a company database 824.

The member profile database 820 stores member profile information about members who have registered with the social networking server 812. With regard to the member profile database 820, the member may include an individual person or an organization, such as a company, a corporation, a nonprofit organization, an educational institution, or other such organizations.

Consistent with some example embodiments, when a user initially registers to become a member of the social networking service provided by the social networking server 812, the user is prompted to provide some personal information, such as name, age (e.g., birth date), gender, profile image, interests, contact information, home town, address, spouse's and/or family members' names, educational background (e.g., schools, majors, matriculation and/or graduation dates, etc.), employment history (e.g., companies worked at, periods of employment for the respective jobs, job titles), professional industry (also referred to herein simply as “industry”), skills, professional organizations, and so on. This information is stored, for example, in the member profile database 820. Similarly, when a representative of an organization initially registers the organization with the social networking service provided by the social networking server 812, the representative may be prompted to provide certain information about the organization, such as a company industry. This information may be stored, for example, in the member profile database 820.

In some example embodiments, the company database 824 stores information regarding companies in the member's profile. A company may also be a member; however, some companies may not be members of the social network even though some of the employees of the company may be members of the social network. The company database 824 includes company information, such as name, industry, contact information, website, address, location, geographic scope; and the like.

As users interact with the social networking service provided by the social networking server 812, the social networking server 812 is configured to monitor these interactions. Examples of interactions include, but are not limited to, commenting on posts entered by other members, viewing member profiles, editing or viewing a member's own profile, sharing content outside of the social networking service (e.g., an article provided by an entity other than the social networking server 812), updating a current status, posting content for other members to view and comment on, posting job suggestions for the members, searching job posts, and other such interactions. In one embodiment, records of these interactions are stored in the member activity database 816, which associates interactions made by a member with his or her member profile stored in the member profile database 820. In one example embodiment, the member activity database 816 includes the posts created by the users of the social networking service for presentation on user feeds.

The jobs database 822 includes job posts for jobs offered by companies in the company database 824. Each job post includes job-related information such as any combination of employer, job title, job description, requirements for the job, salary and benefits, geographic location, one or more job skills required, day the job was posted, relocation benefits, and the like.

In one embodiment, the social networking server 812 communicates with the various databases 816-824 through the one or more database servers) 826. In this regard, the database server(s) 826 provide one or more interfaces and/or services for providing content to, modifying content in, removing content from, or otherwise interacting with the databases 816-824. For example, and without limitation, such interfaces and/or services may include one or more Application Programming Interfaces (APIs), one or more services provided via a Service-Oriented Architecture (SOA), one or more services provided via a Representational State Transfer (REST)-Resource Oriented Architecture (ROA), or combinations thereof.

While the database server(s) 826 are illustrated as a single block, one of ordinary skill in the art will recognize that the database server(s) 826 may include one or more such servers. Accordingly, and in one embodiment, the database server(s) 826 implemented by the social networking service are further configured to communicate with the social networking server 812.

In some example embodiments, the social networking server 812 includes, among other modules, a job-posting manager 828, a budget-modeling module 830, and a recruiter user interface 832. The job-posting manager 828 manages the interactions of job posters with the social network for managing job post-related activities, such as creating, modifying, monitoring, and terminating posts. The recruiter user interface 832 provides the interface for job posters, such as the user interface 102 illustrated in FIG. 1. The budget-modeling module 830 performs the activities for optimizing committed bookings, as described above. The modules may be implemented in hardware, software (e.g., programs), or a combination thereof.

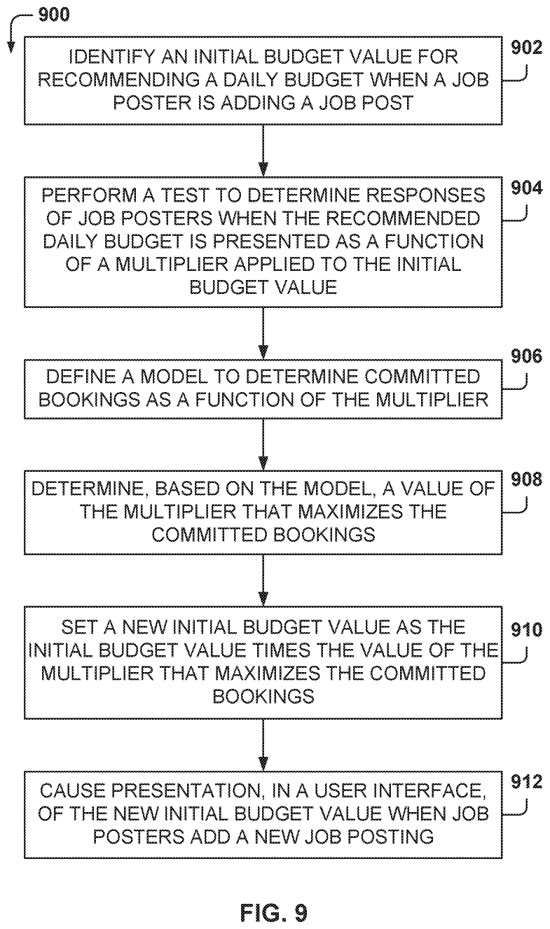

FIG. 9 is a flowchart of a method 900 for determining a recommended daily budget for a job post, according to some example embodiments. While the various operations in this flowchart are presented and described sequentially, one of ordinary skill will appreciate that some or all of the operations may be executed in a different order, be combined or omitted, or be executed in parallel.

At operation 902, an initial budget value is identified for recommending a daily budget when a job poster is adding a job post.

From operation 902, the method 900 flows to operation 904, where one or more processors perform a test to determine responses of job posters when the recommended daily budget is presented as a function of a multiplier applied to the initial budget value.

From operation 904, the method 900 flows to operation 906 for defining a model to determine committed bookings as a function of the multiplier.

From operation 906, the method 900 flows to operation 908 where the one or more processors, based on the model, determine a value of the multiplier that maximizes the committed bookings.

From operation 908, the method 900 flows to operation 910 for setting a new initial budget value to the initial budget value times the value of the multiplier that maximizes the committed bookings.

From operation 910, the method 900 flows to operation 912 for causing presentation, in a user interface, of the new initial budget value when job posters add new job posts.

In one example, defining the model further includes defining a first model for determining a conversion rate as a function of the multiplier, where the conversion rate is a number of jobs posted divided by a number of job post requests started by job posters.

In one example, defining the model further includes defining a second model for determining the recommended daily budget as a function of the multiplier.

In one example, determining the value of the multiplier that maximizes the committed bookings further includes calculating the committed bookings as a function of the multiplier based on predictions for the conversion rate by the first model and predictions for the daily budget by the second model, and finding the value of the multiplier that maximizes the committed bookings based on the calculated committed bookings as a function of the multiplier.

In one example, the model is based on a plurality of machine-learning programs (MLPs) that are trained based on results from the test, where features for the MLPs include one or more of the multiplier, job post features, job-poster features, social-network-profile features, company features, and job-post response features.

In one example, performing the test further includes determining a range for values of the multiplier, and generating random values within the range of the multiplier during the test.

In one example, the committed bookings is calculated as a number of job post requests started by job posters times an average duration that the job post is open times a conversion rate times the multiplier.

In one example, the responses of the job posters are selected from a group consisting of accepting the recommended daily budget, modifying the recommended daily budget, and quitting adding the job post.

In one example, the method 900 further includes providing a user interface for presenting the recommended daily budget with an option to change the daily budget for the job post.

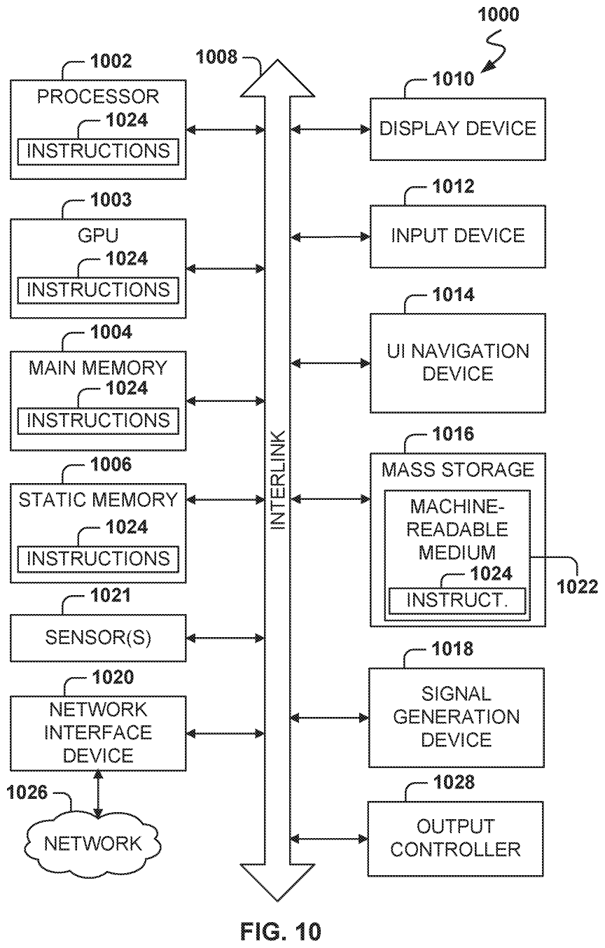

FIG. 10 is a block diagram illustrating an example of a machine 1000 upon or by which one or more example process embodiments described herein may be implemented or controlled. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in a peer-to-peer (P2P) (or other distributed) network environment. Further, while only a single machine 1000 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, by moveable placement of invariant-massed particles, etc.) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1000 may include a hardware processor 1002 (e.g., a central processing unit (CPU), a hardware processor core, or any combination thereof), a graphics processing unit (GPU) 1003, a main memory 1004, and a static memory 1006, some or all of which may communicate with each other via an interlink (e.g., bus) 1008. The machine 1000 may further include a display device 1010, an alphanumeric input device 1012 (e.g., a keyboard), and a user interface (UI) navigation device 1014 (e.g., a mouse). In an example, the display device 1010, alphanumeric input device 1012, and UI navigation device 1014 may be a touch screen display. The machine 1000 may additionally include a mass storage device (e.g., drive unit) 1016, a signal generation device 1018 (e.g., a speaker), a network interface device 1020, and one or more sensors 1021, such as a Global Positioning System (GPS) sensor, compass, accelerometer, or another sensor. The machine 1000 may include an output controller 1028, such as a serial (e.g., universal serial bus (USB)), parallel, or other wired or wireless (e.g., infrared (IR), near field communication (NFC), etc. connection to communicate with or control one or more peripheral devices (e.g., a printer, card reader, etc.).

The mass storage device 1016 may include a machine-readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, within the hardware processor 1002, or within the GPU 1003 during execution thereof by the machine 1000. In an example, one or any combination of the hardware processor 1002, the GPU 1003, the main memory 1004, the static memory 1006, or the mass storage device 1016 may constitute machine-readable media.

While the machine-readable medium 1022 is illustrated as a single medium, the term “machine-readable medium” may include a single medium or multiple media (e.g., a centralized or distributed database, and/or associated caches and servers) configured to store the one or more instructions 1024.

The term “machine-readable medium” may include any medium that is capable of storing, encoding, or carrying instructions 1024 for execution by the machine 1000 and that cause the machine 1000 to perform any one or more of the techniques of the present disclosure, or that is capable of storing, encoding, or carrying data structures used by or associated with such instructions 1024. Non-limiting machine-readable medium examples may include solid-state memories, and optical and magnetic media. In an example, a massed machine-readable medium comprises a machine-readable medium 1022 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Erasable Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device 1020.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
identifying an initial budget value for recommending a daily budget when a job poster is adding a job post;
performing a test, by one or more processors, to determine responses of job posters when the recommended daily budget is presented as a function of a multiplier applied to the initial budget value;
defining, by the one or more processors, a model to determine committed bookings as a function of the multiplier;
determining, based on the model, a value of the multiplier that maximizes the committed bookings;
setting a new initial budget value to the initial budget value times the value of the multiplier that maximizes the committed bookings; and
causing presentation, in a user interface, of the new initial budget value when job posters add new job posts.

2. The method as recited in claim 1, wherein defining the model further includes:
defining a first model for determining a conversion rate as a function of the multiplier, wherein the conversion rate number of jobs posted divided by a number of job post requests started by job posters.

3. The method as recited in claim 2, wherein defining the model further includes:
defining a second model for determining the recommended daily budget as a function of the multiplier.

4. The method as recited in claim 3, wherein determining the value of the multiplier that maximizes the committed bookings further includes:
calculating the committed bookings as a function of the multiplier based on predictions for the conversion rate by the first model and predictions for the daily budget by the second model; and
finding the value of the multiplier that maximizes the committed bookings based on the calculated committed bookings as a function of the multiplier.

5. The method as recited in claim 1, wherein the model is based on a plurality of machine-learning programs (MLPs) that are trained based on results from the test.

6. The method as recited in claim 5, wherein features for the MLPs include one or more of the multiplier, job post features, job-poster features, social-network-profile features, company, features; and job-post response features.

7. The method as recited in claim 1, wherein performing the test further includes:
determining a range for values of the multiplier; and
generating random values within the range of the multiplier during the test.

8. The method as recited in claim 1, wherein the committed bookings is calculated as a number of job post requests started by job posters times an average duration that the job post is open times a conversion rate times the multiplier.

9. The method as recited in claim 1, wherein the responses of the job posters are selected from a group consisting of accepting the recommended daily budget, modifying the recommended daily budget, and quitting adding the job post.

10. The method as recited in claim 1, further comprising:
presenting in the user interface the recommended daily budget with an option to change the recommended daily budget for the job post.

11. A system comprising:
a memory comprising instructions; and
one or more computer processors, wherein the instructions, when executed by the one or more computer processors, cause the one or more computer processors to perform operations comprising:
identifying an initial budget value for recommending a daily budget when a job poster is adding a job post;
performing a test to determine responses of job posters when the recommended daily budget is presented as a function of a multiplier applied to the initial budget value;
defining a model to determine committed bookings as a function of the multiplier;
determining, based on the model, a value of the multiplier that maximizes the committed bookings;
setting a new initial budget value to the initial budget value times the value of the multiplier that maximizes the committed bookings; and
causing presentation, in a user interface, of the new initial budget value when job posters add new job posts.

12. The system as recited in claim 11, wherein defining the model further includes:
defining a first model for determining a conversion rate as a function of the multiplier, wherein the conversion rate number of jobs posted divided by a number of job post requests started by job posters; and
defining a second model for determining the recommended daily budget as a function of the multiplier.

13. The system as recited in claim 12, wherein determining the value of the multiplier that maximizes the committed bookings further includes:
calculating the committed bookings as a function of the multiplier based on predictions for the conversion rate by the first model and predictions for the daily budget by the second model; and
finding the value of the multiplier that maximizes the committed bookings based on the calculated committed bookings as a function of the multiplier.

14. The system as recited in claim 11, wherein the model is based on a plurality of machine-learning programs (MLPs) that are trained based on results from the test, wherein features for the MLPs include one or more of the multiplier, job post features, job-poster features, social-network-profile features, company features, and job-post response features.

15. The system as recited in claim 11, wherein the committed bookings is calculated as a number of job post requests started by job posters times an average duration that the job post is open times a conversion rate times the multiplier.

16. A non-transitory machine-readable storage medium including instructions that, when executed by a machine, cause the machine to perform operations comprising:
identifying an initial budget value for recommending a daily budget when a job poster is adding a job post;
performing a test to determine responses of job posters when the recommended daily budget is presented as a function of a multiplier applied to the initial budget value;
defining a model to determine committed bookings as a function of the multiplier;
determining, based on the model, a value of the multiplier that maximizes the committed bookings;
setting a new initial budget value to the initial budget value times the value of the multiplier that maximizes the committed bookings; and
causing presentation, in a user interface, of the new initial budget value when job posters add new job posts.

17. The non-transitory machine-readable storage medium as recited in claim 16, wherein defining the model further includes:
defining a first model for determining a conversion rate as a function of the multiplier, wherein the conversion rate is a number of jobs posted divided by a number of job post requests started by job posters; and
defining a second model for determining the recommended daily budget as a function of the multiplier.

18. The non-transitory machine-readable storage medium as recited in claim 17, wherein determining the value of the multiplier that maximizes the committed bookings further includes:
calculating the committed bookings as a function of the multiplier based on predictions for the conversion rate by the first model and predictions for the daily budget by the second model; and
finding the value of the multiplier that maximizes the committed bookings based on the calculated committed bookings as a function of the multiplier.

19. The non-transitory machine-readable storage medium as recited in claim 16, wherein the model is based on a plurality of machine-learning programs (MLPs) that are trained based on results from the test, wherein features for the MLPs include one or more of the multiplier, job post features, job-poster features, social-network-profile features, company features, and job-post response features.

20. The non-transitory machine-readable storage medium as recited in claim 16, wherein the committed bookings is calculated as a number of job post requests started by job posters times an average duration that the job post is open times a conversion rate times the multiplier.
